(19) United States
(12) Patent Application Publication
(10) Pub. No.: US 2015/0277604 A1
(43) Pub. Date: Oct. 1, 2015

(54) TOUCH SENSOR MODULE

(71) Applicant: SAMSUNG ELECTRO-MECHANICS CO., LTD., Gyeonggi-Do (KR)

(72) Inventors: Young An CHOI, Gyeonggi-Do (KR); Kyoung Soo CHAE, Gyeonggi-Do (KR); Ji Soo LEE, Gyeonggi-Do (KR); Yun Ki HONG, Gyeonggi-Do (KR); Seung Hoon HAN, Gyeonggi-Do (KR)

(73) Assignee: SAMSUNG ELECTRO-MECHANICS CO., LTD., Gyeonggi-Do (KR)

(21) Appl. No.: 14/609,669

(22) Filed: Jan. 30, 2015

(30) Foreign Application Priority Data
Mar. 27, 2014 (KR) 10-2014-0035916

(51) Int. Cl. G06F 3/041

(52) U.S. Cl. CPC G06F 3/041; G06F 2203/04102; G06F 2203/04103

(57) ABSTRACT

Embodiments of the invention provide a touch sensor module including a base substrate having electrode patterns formed thereon and including electrode pads transferring electrical signals of the electrode patterns to the outside, a flexible cable including an adhesive layer contacting one surface of the electrode pad and formed to transfer the electrical signal, and a curvature adhesive having an end portion of one side formed to be in contact with the base substrate and an end portion of the other side formed to be in contact with the flexible cable.

### CROSS REFERENCE TO RELATED APPLICATION

This application claims the benefit of and priority under 35 U.S.C. §119 to Korean Patent Application No. KR 10-2014-0035916, entitled “TOUCH SENSOR MODULE,” filed on Mar. 27, 2014, which is hereby incorporated by reference in its entirety into this application.

### BACKGROUND

1. Field of the Invention

The present invention relates to a touch sensor module.

2. Description of the Related Art

In accordance with the growth of computers using a digital technology, devices assisting computers have also been developed, and personal computers, portable transmitters and other personal information processors execute processing of text and graphic using a variety of input devices, such as a keyboard and a mouse.

However, in accordance with the rapid advancement of an information-oriented society, the use of computers has gradually been widened. Therefore, it is difficult to efficiently operate products using only the keyboard and the mouse currently serving as the input device. Therefore, the necessity for a device that is simple, has minimum malfunction, and is capable of easily inputting information by anybody has increased.

In addition, techniques for input devices have progressed toward techniques related to high reliability, durability, innovation, designing and processing beyond a level of satisfying general functions. To this end, a touch sensor has been developed as an input device capable of inputting information, such as text or graphics, as non-limiting examples.

This touch sensor is mounted on a display surface of a display, such as an electronic organizer, a flat panel display device including a liquid crystal display (LCD) device, a plasma display panel (PDP), or an electroluminescence (El) element, as non-limiting examples, and a cathode ray tube (CRT) to thereby be used to allow a user to select desired information while viewing the display.

In addition, the touch sensor is classified into a resistive type touch sensor, a capacitive type touch sensor, an electromagnetic type touch sensor, a surface acoustic wave (SAW) type touch sensor, and an infrared type touch sensor.

These various types of touch sensors are adopted for electronic products in consideration of a signal amplification problem, a resolution difference, a level of difficulty of designing and processing technologies, optical characteristics, electrical characteristics, mechanical characteristics, environment resistance, input characteristics, durability, and economic efficiency. Currently, the resistive type touch sensor and the capacitive type touch sensor have been prominently used in a wide range of fields.

As a specific example of a touch sensor according to the conventional art, there may be a touch sensor disclosed in Korean Patent Publication No. 10-2011-0107590. Describing a structure of the touch sensor disclosed in a description of the conventional art in a content of Korean Patent Publication No. 10-2011-0107590, the touch sensor is configured to include a substrate, electrodes formed on the substrate, electrode wirings extended from the electrodes and gathered on one end of the substrate, and a controller connected to the electrode wirings through a flexible printed circuit board (hereinafter, referred to as ‘flexible cable’).

Here, the flexible cable serves to transfer signals generated in the electrode to the controller through the electrode wirings. In this case, the flexible cable electrically contacts and is connected to the electrode wiring in order to transfer a signal. However, the flexible cable and the electrode wrings has a problem that connection defect may occur at a connection portion of the product due to a curvature depending on an assemble state.

### SUMMARY

Accordingly, embodiments of the invention have been made to provide a touch sensor module capable of preventing malfunction due to a curvature when a flexible cable (FPCB) is coupled to an electronic part by forming a curvature adhesive on the flexible cable to be in contact with the flexible cable.

According to at least one embodiment of the invention, there is provided a touch sensor module including a base substrate having electrode patterns formed thereon and including electrode pads transferring electrical signals of the electrode patterns to the outside, a flexible cable including an adhesive layer contacting one surface of the electrode pad and formed to transfer the electrical signal, and a curvature adhesive having an end portion of one side formed to be in contact with the base substrate and an end portion of the other side formed to be in contact with the flexible cable.

According to at least one embodiment, an end portion of one side of the flexible cable is formed to be in contact with one surface of the electrode pad and an end portion of the other side of the flexible cable is formed to be electrically connected to a controlling unit and an electronic part while having a curvature.

According to at least one embodiment, the adhesive layer is made of an anisotropic conductive film (ACF) or an anisotropic conductive adhesive (ACA).

According to at least one embodiment, a material of the curvature adhesive uses an optical clear adhesive (OCA) or a double adhesive tape (DAT).

According to at least one embodiment, the curvature adhesive is formed to surround the end portion of one side of the flexible cable and is formed to be adhered to the base substrate.

According to at least one other embodiment, there is provided a touch sensor module including a window substrate, a base substrate formed to face the window substrate and having electrode patterns formed thereon, a flexible cable formed on an end portion of one side of the base substrate and formed to transfer an electrical signal, and a curvature adhesive having an end portion of one side formed on the base substrate and an end portion of the other side formed to be in contact with the flexible cable.

According to at least one embodiment, the base substrate has the electrode patterns formed on the other surface facing the window substrate.

According to at least one embodiment, an end portion of one side of the flexible cable is formed to be in contact with the electrode pad electrically connected to the electrode pattern and an end portion of the other side of the flexible cable is formed to be electrically connected to an electronic part disposed to face the window substrate.

According to at least one embodiment, a material of the curvature adhesive uses an optical clear adhesive (OCA) or a double adhesive tape (DAT).

According to at least one embodiment, the curvature adhesive is formed to surround an end portion of one side of the flexible cable and is formed to adhere to the base substrate.

According to at least one embodiment, the touch sensor module further includes an adhesive layer formed between the base substrate and the flexible cable and transferring the electrical signal.

According to at least one embodiment, the adhesive layer is made of an anisotropic conductive film (ACF) or an anisotropic conductive adhesive (ACA).

According to at least one embodiment, the base substrate includes one surface having a first electrode pattern formed thereon and a first electrode pad transferring an electrical signal of the first electrode pattern to the outside, and the other surface having a second electrode pattern formed thereon and a second electrode pad transferring an electrical signal of the second electrode pattern to the outside.

According to at least one embodiment, a material of the curvature adhesive uses an optical clear adhesive (OCA) or a double adhesive tape (DAT).

According to at least one embodiment, the curvature adhesive is formed to surround an end portion of one side of the flexible cable and is formed to adhere to the base substrate.

According to at least one embodiment, the touch sensor module further includes an adhesive layer formed between the base substrate and the flexible cable and transferring the electrical signal.

According to at least one embodiment, the adhesive layer is made of an anisotropic conductive film (ACF) or an anisotropic conductive adhesive (ACA).

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view of a touch sensor module and a flexible cable according to an embodiment of the invention.

FIG. 2 is a partial view showing a top and a bottom of a base substrate to which the touch sensor module and the flexible cable are coupled according to an embodiment of the invention.

FIG. 3 is a top assembled cross-sectional view of the touch sensor module and the flexible cable taken along line A of FIG. 2 according to an embodiment of the invention.

FIG. 4 is a bottom assembled cross-sectional view of the touch sensor module and the flexible cable taken along line B of FIG. 2 according to an embodiment of the invention.

FIG. 5 is a plan view of a portion in which a curvature adhesive is formed on an upper surface of the flexible cable of FIG. 1 according to an embodiment of the invention.

FIG. 6 is a cross-sectional view of a touch sensor module and a flexible cable according to another embodiment of the invention.

FIG. 7 is a cross-sectional view of an electrode pattern of FIG. 6 according to another embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

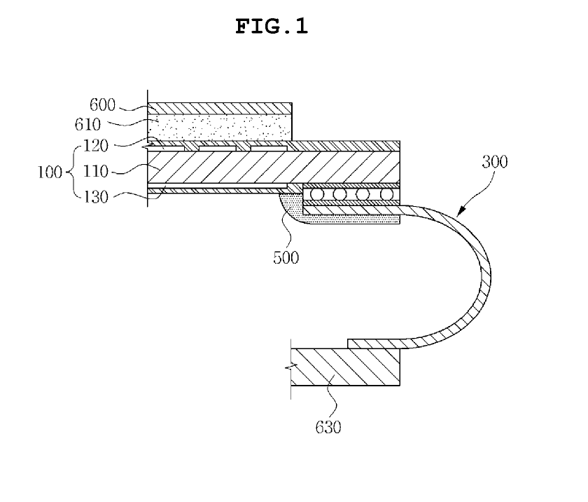

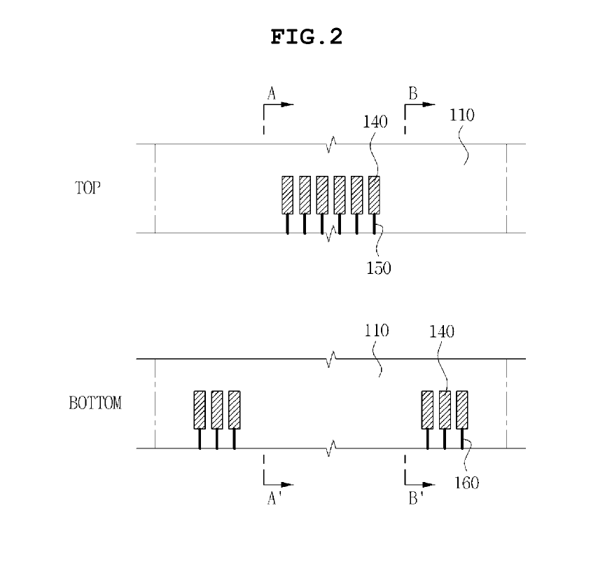

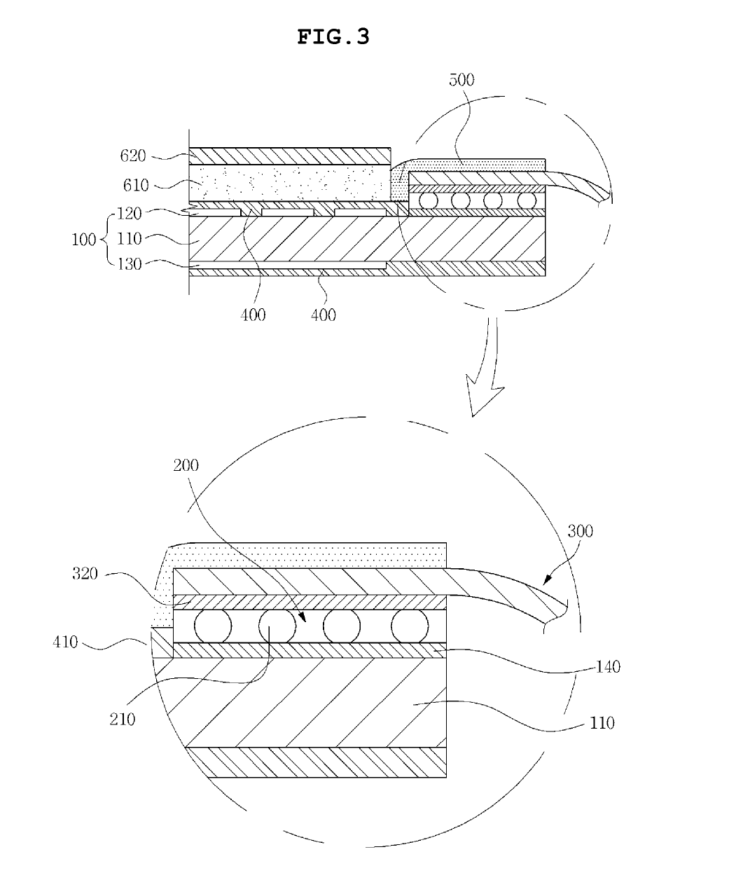

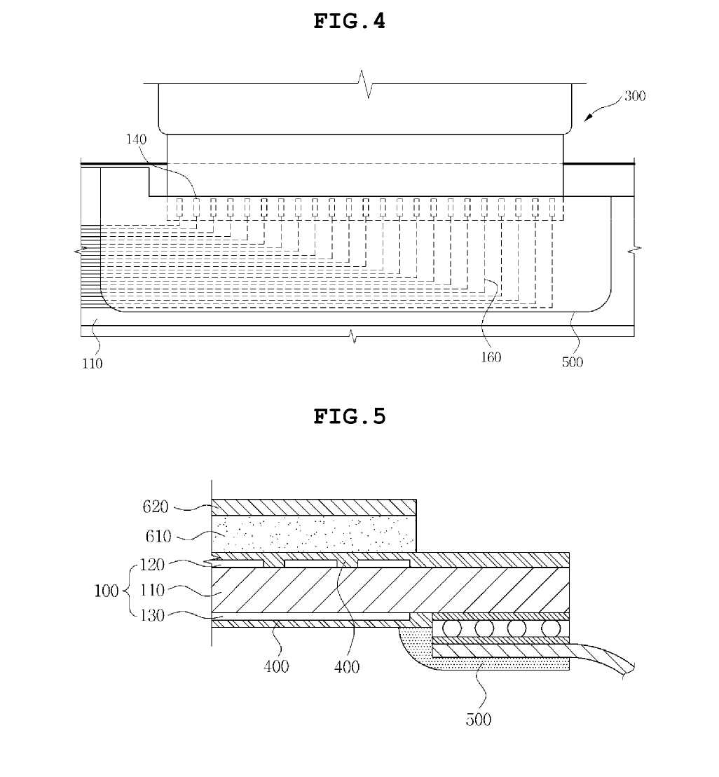

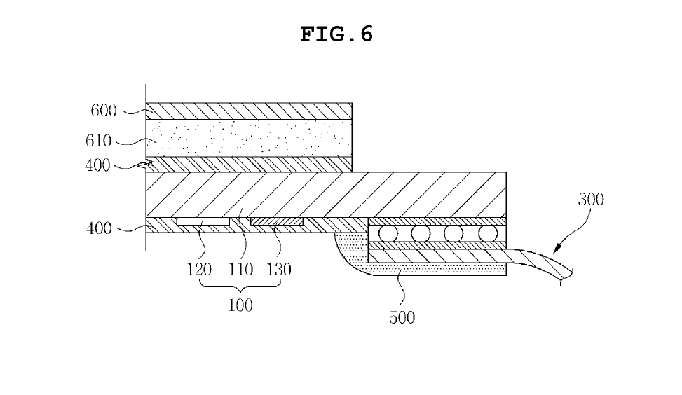

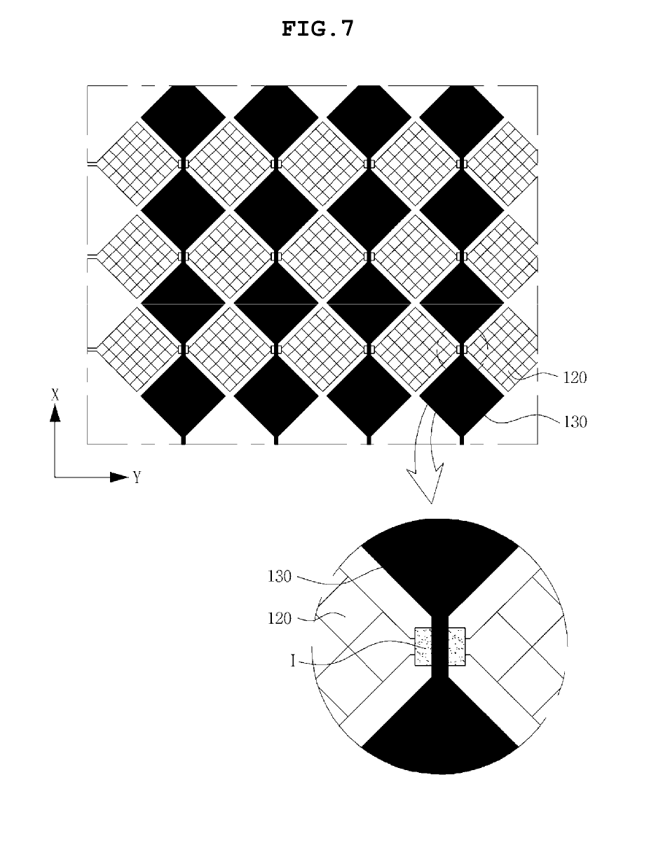

FIG. 1 is a cross-sectional view of a touch sensor module and a flexible cable according to an embodiment of the invention, FIG. 2 is a partial view showing a top and a bottom of a base substrate to which the touch sensor module and the flexible cable are coupled according to an embodiment of the invention, FIG. 3 is a top assembled cross-sectional view of the touch sensor module and the flexible cable taken along line A of FIG. 2, FIG. 4 is a bottom assembled cross-sectional view of the touch sensor module and the flexible cable taken along line B of FIG. 2, FIG. 5 is a plan view of a portion in which a curvature adhesive is formed on an upper surface of the flexible cable of FIG. 1, FIG. 6 is a cross-sectional view of a touch sensor module and a flexible cable according to another embodiment of the invention, and FIG. 7 is a cross-sectional view of an electrode pattern of FIG. 6.

A term ‘touch’ used throughout the present specification should be widely interpreted to mean that an input unit becomes significantly close to a contact accommodating surface as well as mean that the input unit directly contacts the contact accommodating surface.

A touch sensor module 1 according to at least one embodiment of the invention includes a base substrate 110 having electrode patterns 120 and 130 formed thereon and including an electrode pad 140 transferring electrical signals of the electrode patterns 120 and 130 to the outside, a flexible cable 300 including an adhesive layer 200 contacting one surface of the electrode pad 140 and formed to transfer the electrical signals, and a curvature adhesive 500 having an end portion of one side formed to be in contact with the base substrate 110 and an end portion of the other side formed to be in contact with the flexible cable 300.

According to at least one embodiment, various touch sensors 100, such as a resistive type touch sensor or a capacitive type touch sensor, as non-limiting examples, are used as a touch sensor 100. However, a form and a kind of touch sensor 100 are not particularly limited. However, in the touch sensor module 1 according to at least one embodiment, a capacitive type touch sensor 100 having electrode patterns 120 and 130 formed on both surfaces of the base substrate 110 will be described by way of example.

Referring to FIG. 1, a window substrate 600 is a window provided at the outermost portion of the touch sensor. According to at least one embodiment, in the case in which the window substrate 600 is the window, since the electrode patterns 120 and 130 are formed directly on the window, a process of forming the electrode patterns 120 and 130 on a separate base substrate 110 and then attaching the base substrate 110 to the window is omitted, thereby making it possible to simplify a manufacturing process. The window substrate 600 uses the same material as the base substrate 110 to be described below.

According to at least one embodiment, the window substrate 600 has a transparent adhesive layer 610 formed on a lower end portion thereof so as to be coupled to the base substrate 110. As the transparent adhesive layer 610, a transparent material may be used to not interfere with recognition by a user of an output image and an optical clear adhesive (OCA) may be used, for example.

Referring to FIGS. 1 to 5, the base substrate 110 is coupled to the window substrate 600. The base substrate 110 serves to provide a region in which the electrode patterns 120 and 130 and electrode wirings 150 and 160 are to be formed. According to at least one embodiment, the base substrate 110 is divided into an active region and a bezel region, wherein the active region, which is a portion provided with the electrode patterns 120 and 130 to recognize a touch of an input unit, is formed at the center of the base substrate 110 and the bezel region, which is a portion provided with the electrode wirings 150 and 160 extended from the electrode patterns 120 and 130, is formed at an edge of the active region. According to at least one embodiment, the base substrate 110 should have support force capable of supporting the electrode patterns 120 and 130 and the electrode wirings 150 and 160 and transparency capable of allowing a user to recognize an image provided by an electronic part 630 (an image display device). In consideration of the support force and the transparency, the base substrate 110 is made of, for example, polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass, reinforced glass, as non-limiting examples, but is not necessarily limited thereto.

According to at least one embodiment, the electrode patterns 120 and 130, which serve to generate a signal at the time of being touched by an input unit to allow a controller to recognize a touch coordinate, are formed on the base substrate 110. According to at least one embodiment, an electrode pattern formed in an X axis direction of the base substrate 110 will be referred to as a first electrode pattern 120, and an electrode pattern formed in a Y axis direction of the base substrate 110 will be referred to as a second electrode pattern 130.

According to at least one embodiment, the electrode patterns 120 and 130 are formed, for example, by a plating process or an evaporation process using a sputter. The electrode pattern 120 and 130 is made of a metal formed by exposing/developing a silver salt emulsion layer. More specifically, it is obvious to those skilled in the art that the electrode patterns 120 and 130 may be made of various kinds of metals that have conductivity and are capable of forming mesh patterns. According to at least one embodiment, the electrode patterns 120 and 130 are formed in all shapes known in the art, such as a diamond shape, a rectangular shape, a triangular shape, or a circular shape, as non-limiting examples.

According to at least one embodiment, the electrode wirings 150 and 160 are electrically connected to the electrode patterns 120 and 130 described above through the flexible cable 300 (see FIGS. 2 to 4). The electrode wiring 150 and 160 are formed on the base substrate 110 by various printing methods, such as a silk screen method, a gravure printing method, or an inkjet printing method, as non-limiting examples. According to at least one embodiment, the electrode wirings 150 and 160 are made of, for example, copper (Cu), aluminum (Al), gold (Au), silver (Ag), titanium (Ti), palladium (Pd), or chromium (Cr). The electrode wirings 150 and 160 are made of silver (Ag) paste or organic silver having excellent electrical conductivity. However, the electrode wirings are not limited to being made of the above-mentioned materials, but may be made of, for example, a conductive polymer, carbon black (containing CNT), a metal oxide, such as ITO, or a low resistance metal material such metals, as non-limiting examples.

According to at least one embodiment, the electrode wirings 150 and 160 are connected to only one end of the electrode pattern 120 depending on a scheme of the touch sensor module 1. The electrode wirings 150 and 160 have the electrode pads 140 disposed at distal end portions thereof, wherein the electrode pads 140 are electrically connected to the flexible cable 300. In other words, the electrode pads 140 are formed at one portion of the electrode wirings 150 and 160 and are electrically connected to the flexible cable 300.

According to at least one embodiment, the electrode pads 140 are connected to the electrode wirings 150 and 160 and are formed on the base substrate 110 (see FIG. 2). The electrode pads 140 are formed so as not to invade the flexible cable 300 and the active region of the base substrate 110, that is, a region in which a touch of the user is recognized. The electrode pads 140 are positioned at distal end portions of one side of the base substrate 110 and are connected to the electrode wirings 150 and 160. The electrode pads 140 contact the adhesive layer 200 to allow electricity to be conducted to the flexible cable 300. The electrode pads 140 are coupled to the adhesive layer 200 by pressing the flexible cable 300. In this case, the electrode pads 140 are coupled to the adhesive layer 200 in a direction in which the base substrate 110 is stacked. The electrode pads 140 have a contact surface contacting conductive balls 210 of the adhesive layer 200. The contact surface has a diameter larger than that of the conductive ball 210. A plurality of electrode pads 140 is disposed at a distal end portion of one side of the base substrate 110. According to at least one embodiment, the electrode pads 140 are formed to be spaced apart from each other by a predetermined distance so that electrical interference between adjacent electrode pads is not generated.

Embodiments of the invention further improve characteristics, such as moisture resistance and environment resistance of the touch sensor module 1, and maintains operation reliability against moisture and electrical conduction by attaching a curvature adhesive 500 onto the flexible cable 300 and the base substrate 110. Therefore, convenience of the user and fields of the products in which the touch sensor module is used is further diversified.

Passivation layers 400 correspond to the electrode pads 140 (see FIGS. 3 and 5). The passivation layers 400 prevent the moisture from permeating into the electrode patterns 120 and 130, the electrode wirings 150 and 160, and the electrode pads 140. The passivation layers 400 stabilize an electrical conduction state while blocking a harmful environment of a surface or a bonding portion of the base substrate. According to at least one embodiment, the passivation layer 400 is an insulating film made of silicon dioxide (SiO₂) or silicon nitride (SiN) or a complex structure including those as mentioned above, or may be made of material such as polyimide or epoxy, as non-limiting examples. The passivation layers 400 prevent the moisture permeation and corrosion while protecting active surfaces of the electrode patterns 120 and 130 and the electrode pads 140.

According to at least one embodiment, the adhesive layer 200 contacts the electrode pad 140 and is electrically connected thereto. In the case in which the adhesive layer 200 is pressed to thereby be coupled or adhered, an inner portion of the adhesive layer 200 is provided with the conductive balls 210 having conductivity. The conductive balls 210 conduct electricity in one direction while being pressed to thereby be bonded in a process of coupling the electrode pad 140 and a terminal part 320 to each other. The adhesive layer 200 has a lower end surface connected to the electrode pad 140 and an upper end surface coupled and adhered to the terminal part 320. Thus, the conductive ball 210 disposed in the adhesive layer 200 has one surface adhered to the electrode pad 140 and the other surface adhered to the terminal part 320. This is not to limit a form in which the adhesive layer 200 is adhered to the electrode pad 140 and the terminal part 320.

It is preferable that the adhesive layer 200 is made of an anisotropic conductive film (ACF). In some cases, the adhesive layer 200 is made of a conductive material, such as an anisotropic conductive adhesive (ACA), as a non-limiting example.

According to at least one embodiment, the flexible cable 300 is coupled to the electrode pad 140 to correspond to the electrode pad 140. The flexible cable 300 includes terminal parts 320 and 330 contacting the adhesive layer 200. The flexible cable 300 is electrically connected to the electrode pad 140 to electrically connect the electrode patterns 120 and 130 and a controller and the electronic part 630 to each other. Thus, an end portion of one side of the flexible cable 300 is formed to contact the electrode pad 140 and an end portion of the other side is electrically connected to the controlling unit and the electronic part 630. In this case, the flexible cable 300 has a curvature formed according to positions of the controller and the electronic part 630. For example, when the positions in which the controller and the electronic part 630 are formed are formed at a lower end portion of the base substrate 110, the flexible cable 300 has a sharp curvature (see FIG. 1). In this case, a curvature adhesive 500 to be described below has an effect suppressing a delamination phenomenon of a starting point of the curvature. The terminal parts 320 and 330 are in contact with the conductive balls 210, such that they are electrically connected to each other. The terminal parts 320 and 330 are formed at positions corresponding to those of the plurality of electrode pads 140.

According to at least one embodiment, the base substrate 110 and the flexible cable 300 are integrally adhered to each other by the curvature adhesive 500. Thus, the end portion of one side of the curvature adhesive 500 is in contact with base substrate 110 and the end portion of the other side thereof is in contact with the flexible cable 300. The curvature adhesive 500 prevents the delamination phenomenon by pressing the curvature starting point of the flexible cable 300. In this case, the curvature adhesive 500 surrounds the end portion of one side of the flexible cable 300 and is in contact with the base substrate 110. That is, the curvature adhesive 500 is adhered to the base substrate 110 across the terminal parts 320 and 330. As the curvature adhesive 500, an optical clear adhesive (OCA), or a double adhesive tape (DAT), for example, are appropriately used.

According to at least one embodiment, the curvature adhesive 500 is formed by applying an adhesive onto surfaces of the base substrate 110 and the flexible cable 300. The curvature adhesive 500 has different thicknesses of the adhesive applied onto the base substrate 110 and the flexible cable 300. This is to solve adhesive force and corrosion due to steps between the base substrate 110 and the flexible cable 300, and disconnection due to the curvature.

According to at least one embodiment, the curvature adhesive 500 is differently formed depending on an adhesive form. For example, the base substrate 110 and the flexible cable 300 are integrally adhered to each other by using the adhesive tape as the curvature adhesive 500. In this case, the curvature adhesive 500 is formed up to ends of the terminal parts 320 and 330. This is to prevent the delamination phenomenon due to the curvature when the curvature adhesive 500 connects the flexible cable 300 to the controlling unit and the electronic product 630.

Hereinafter, a description of structures and materials of a base substrate 110, an adhesive layer 200, a flexible cable 300, a curvature adhesive 500, and a window substrate 600 of a touch sensor module 1 according to at least another embodiment that are the same as those of the touch sensor module according previously described embodiments will be omitted, and electrode patterns 120 and 130 of the touch sensor module 1 according to at least another embodiment will be described in detail with reference to FIGS. 6 and 7.

According to at least one embodiment, the electrode patterns 120 and 130 are formed on one surface of the base substrate 110, and a touch sensor is formed to have single-layer electrode patterns 120 and 130. In a touch sensor module according to at least another embodiment, first electrode patterns 120 in an X axis direction and second electrode patterns 130 in a Y axis direction intersecting with the first electrode patterns 120 are formed on the base substrate 110 (see FIG. 7). In order to form the first electrode patterns 120 and the second electrode patterns 130 on a single surface to intersect with each other, insulating patterns I are formed on any one of the first and second electrode patterns 120 and 130 at portion at which the first and second electrode patterns 120 and 130 intersect with each other, and the other of the first and second electrode patterns 120 and 130 are electrically connected to each other on the insulating patterns I, such that the first electrode patterns 120 and the second electrode patterns 130 intersecting with each other may implement an electrical connection. Although the case in which the first electrode patterns 120 and the second electrode patterns 130 intersect with each other to be perpendicular to each other has been shown, an angle at which the first electrode patterns 120 and the second electrode patterns 130 intersect with each other is not particularly limited. Thus, the first electrode patterns 120 and the second electrode patterns 130 appropriately intersect with each other at an appropriate angle as long as an X-axis coordinate and a Y-axis coordinate are extracted so that coordinates on a two-dimensional plane are extracted.

According to at least one embodiment, the electrode patterns 120 and 130 are formed on one surface of the base substrate 110. As described above, in the touch sensor module according to at least another embodiment, the first electrode patterns 120 and the second electrode patterns 130 intersecting with each other may be simultaneously formed on one surface of the base substrate 110. Here, the electrode patterns 120 and 130 are formed in a mesh pattern, which is formed of metal fine lines, and the mesh pattern is not limited to having a specific shape, but has a polygonal shape, such as a rectangular shape, a triangular shape, or a diamond shape, as non-limiting examples. The electrode patterns 120 and 130 may be formed in the mesh pattern using copper (Cu), aluminum (Al), gold (Au), silver (Ag), titanium (Ti), palladium (Pd), chromium (Cr), nickel (Ni) or a combination thereof.

According to at least one embodiment, the electrode patterns 120 and 130 are formed, for example, by a dry process, a wet process, or a direct patterning process. Here, the dry process includes, for example, a sputtering process or an evaporation process, as non-limiting examples, the wet process includes, for example, a dip coating process, a spin coating process, a roll coating process, or a spray coating process, as non-limiting examples, and the direct patterning process includes, for example, a screen printing process, a gravure printing process, or an inkjet printing process, as non-limiting examples.

As set forth above, according to various embodiments of the invention, the curvature adhesive is formed on the flexible cable to be in contact with the flexible cable, thereby making it possible to prevent disconnection, a contact defect, and a malfunction between the electrode pad and the flexible cable (FPCB).

In addition, the curvature adhesive is formed on the flexible cable to be in contact with the flexible cable, such that an electrical short circuit between the electrode pad and the flexible cable (FPCB) is prevented, thereby making it possible to secure reliability of a product.

In addition, the curvature adhesive is formed on the flexible cable to be in contact with the flexible cable, thereby making it possible to improve a delamination phenomenon caused because the flexible cable (FPCB) has the curvature.

In addition, the curvature adhesive is formed on the flexible cable to be in contact with the flexible cable, thereby making it possible to block moisture permeated into the electrode pattern in advance.

In addition, the curvature adhesive is formed on the flexible cable to be in contact with the flexible cable, thereby making it possible to improve an electrical conduction phenomenon by the electrode pattern and the curvature by using an existing process.

In addition, the curvature adhesive is formed on the flexible cable to be in contact with the flexible cable, thereby making it possible to minimize an exposed portion of the electrode pattern to prevent corrosion of the wiring.

In addition, the curvature adhesive is formed on the flexible cable to be in contact with the flexible cable, thereby making it possible to solve an electrical disconnection due to a continuous stress.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor module, comprising:
a base substrate comprising electrode patterns formed thereon and comprising electrode pads transferring electrical signals of the electrode patterns to the outside;
a flexible cable comprising an adhesive layer contacting one surface of the electrode pad and formed to transfer the electrical signal; and
a curvature adhesive comprising an end portion of one side formed to be in contact with the base substrate and an end portion of the other side formed to be in contact with the flexible cable.

2. The touch sensor module of claim 1, wherein an end portion of one side of the flexible cable is formed to be in contact with one surface of the electrode pad and an end portion of the other side of the flexible cable is formed to be electrically connected to a controlling unit and an electronic part while having a curvature.

3. The touch sensor module of claim 1, wherein the adhesive layer is made of an anisotropic conductive film (ACF) or an anisotropic conductive adhesive (ACA).

4. The touch sensor module of claim 2, wherein a material of the curvature adhesive uses an optical clear adhesive (OCA) or a double adhesive tape (DAT).

5. The touch sensor module of claim 4, wherein the curvature adhesive is formed to surround the end portion of one side of the flexible cable and is formed to be adhered to the base substrate.

6. A touch sensor module, comprising:
a window substrate;
a base substrate formed to face the window substrate and comprising electrode patterns formed thereon;
a flexible cable formed on an end portion of one side of the base substrate and formed to transfer an electrical signal; and
a curvature adhesive comprising an end portion of one side formed on the base substrate and an end portion of the other side formed to be in contact with the flexible cable.

7. The touch sensor module of claim 6, wherein the base substrate comprises the electrode patterns formed on the other surface facing the window substrate.

8. The touch sensor module of claim 7, wherein an end portion of one side of the flexible cable is formed to be in contact with the electrode pad electrically connected to the electrode pattern and an end portion of the other side of the flexible cable is formed to be electrically connected to an electronic part disposed to face the window substrate.

9. The touch sensor module of claim 7, wherein a material of the curvature adhesive uses an optical clear adhesive (OCA) or a double adhesive tape (DAT).

10. The touch sensor module of claim 7, wherein the curvature adhesive is formed to surround an end portion of one side of the flexible cable and is formed to be adhered to the base substrate.

11. The touch sensor module of claim 7, further comprising:
an adhesive layer formed between the base substrate and the flexible cable and transferring the electrical signal.

12. The touch sensor module of claim 11, wherein the adhesive layer is made of an anisotropic conductive film (ACF) or an anisotropic conductive adhesive (ACA).

13. The touch sensor module of claim 6, wherein the base substrate comprises one surface having a first electrode pattern formed thereon and a first electrode pad transferring an electrical signal of the first electrode pattern to the outside, and the other surface having a second electrode pattern formed thereon and a second electrode pad transferring an electrical signal of the second electrode pattern to the outside.

14. The touch sensor module of claim 13, wherein a material of the curvature adhesive uses an optical clear adhesive (OCA) or a double adhesive tape (DAT).

15. The touch sensor module of claim 13, wherein the curvature adhesive is formed to surround an end portion of one side of the flexible cable and is formed to be adhered to the base substrate.

16. The touch sensor module of claim 13, further comprising:
an adhesive layer formed between the base substrate and the flexible cable and transferring the electrical signal.

17. The touch sensor module of claim 16, wherein the adhesive layer is made of an anisotropic conductive film (ACF) or an anisotropic conductive adhesive (ACA).
